(19) United States
(12) Patent Application Publication
(10) Pub. No.: US 2026/0291284 A1
(43) Pub. Date: Sep. 24, 2026

(54) ELECTRONIC DEVICE INCLUDING COIL ASSEMBLY

(71) Applicant: Samsung Electronics Co., Ltd., Suwon-si (KR)

(72) Inventors: Gyuyeong CHO, Suwon-si (KR); Jaedeok LIM, Suwon-si (KR); Jongkui PARK, Suwon-si (KR)

(21) Appl. No.: 19/414,674

(22) Filed: Dec. 10, 2025

Related U.S. Application Data
(63) Continuation of application No. PCT/KR2025/021030, filed on Dec. 9, 2025.

(30) Foreign Application Priority Data
Mar. 18, 2025 (KR) 10-2025-0034548
Mar. 28, 2025 (KR) 10-2025-0040144

(51) Int. Cl. H02J 50/00; H02J 50/10; H02J 50/40; H04M 1/02

(52) U.S. Cl. CPC H02J 50/005; H02J 50/10; H02J 50/402; H04M 1/026

(57) ABSTRACT

An electronic device is provided. The electronic device includes a housing including a rear plate forming a rear surface facing a first direction of the electronic device, a coil assembly disposed adjacent to the rear plate in a second direction opposite to the first direction, and configured to transmit or receive power, wherein the coil assembly includes a first coil configured to transmit power to an external electronic device and having a ring shape when viewed from the second direction, a second coil configured to receive power from a wireless power transmission device outside of the electronic device, the second coil having a ring shape surrounding an outer peripheral surface of the first coil when viewed from the second direction, a third coil configured to transmit power to the external electronic device or receive power from the wireless power transmission device and having a ring shape surrounding an outer peripheral surface of the second coil when viewed from the second direction, and wherein the first coil and the second coil are electrically connected in parallel, and the third coil is electrically connected in series with the first coil and the second coil.

### CROSS-REFERENCE TO RELATED APPLICATION(S)

This application is a continuation application, claiming priority under 35 U.S.C. § 365 (c), of an International application No. PCT/KR2025/021030, filed on Dec. 9, 2025, which is based on and claims the benefit of a Korean patent application number 10-2025-0034548, filed on Mar. 18, 2025, in the Korean Intellectual Property Office, and of a Korean patent application number 10-2025-0040144, filed on Mar. 28, 2025, in the Korean Intellectual Property Office, the disclosure of each of which is incorporated by reference herein in its entirety.

### TECHNICAL FIELD

The disclosure relates to an electronic device. More particularly, the disclosure relates to an electronic device including a coil assembly.

### BACKGROUND ART

The growth of electronics, information, and communication technologies leads to integration of various functions into a single electronic device. For example, electronic devices (e.g., smartphones) pack the functionalities of a sound player, imaging device, scheduler, and charger as well as the communication functionality and, on top of that, may implement more various functions by having applications installed thereon. An electronic device may not only its equipped applications or stored functions but also access, wiredly or wirelessly, a server or another electronic device to receive, in real-time, various pieces of information. Further, wireless charging technology may be included.

Wireless charging technology uses wireless power transmission/reception to charge a battery of an electronic device (e.g., a mobile phone) without connecting a separate charging connector, or to charge an external electronic device (e.g., a smart watch) through an electronic device (e.g., a mobile phone).

The wireless power transmission device may transfer power using one or more of an inductive coupling scheme based on an electromagnetic induction phenomenon by the wireless power signal and an electromagnetic resonance coupling scheme based on an electromagnetic resonance phenomenon by the wireless power signal of a specific frequency.

An electronic device that supports wireless charging power reception may receive power from an external device through an antenna and charge a battery using the input power. An electronic device that supports wireless charging power transmission may supply wireless power to another electronic device using the power from the battery or power input from a connected wired charger. For example, the wireless charging power transmission device may generate designated power using the power from an external device (e.g., a travel adapter (TA adapter)) or a battery and supply the generated power to the other electronic device (e.g., a smartphone, a smart watch, or a wireless earphone (e.g., true wireless stereo)) through the coil.

The above information is presented as background information only to assist with an understanding of the disclosure. No determination has been made, and no assertion is made, as to whether any of the above might be applicable as prior art with regard to the disclosure.

### DISCLOSURE OF INVENTION

### Solution to Problems

Aspects of the disclosure are to address at least the above-mentioned problems and/or disadvantages and to provide at least the advantages described below. Accordingly, an aspect of the disclosure is to provide an electronic device including a coil assembly.

Additional aspects will be set forth in part in the description which follows and, in part, will be apparent from the description, or may be learned by practice of the presented embodiments.

In accordance with an aspect of the disclosure, an electronic device is provided. The electronic device includes a housing including a rear plate forming a rear surface facing a first direction of the electronic device, a coil assembly disposed adjacent to the rear plate in a second direction opposite to the first direction and configured to transmit or receive power, wherein the coil assembly includes a first coil configured to transmit power to an external electronic device and having a ring shape when viewed from the second direction, a second coil configured to receive power from a wireless power transmission device and having a ring shape surrounding an outer peripheral surface of the first coil when viewed from the second direction, and a third coil configured to transmit power to the external electronic device or receive power from the wireless power transmission device and having a ring shape surrounding an outer peripheral surface of the second coil when viewed from the second direction, wherein the first coil and the second coil are electrically connected in parallel, and the third coil is electrically connected in series with the first coil and the second coil.

In accordance with another aspect of the disclosure, an electronic device is provided. The electronic device includes a housing including a rear plate forming a rear surface facing a first direction of the electronic device, a coil assembly disposed adjacent to the rear plate in a second direction opposite to the first direction and configured to transmit or receive power, wherein the coil assembly includes a first coil configured to transmit power to an external electronic device and having a ring shape when viewed from the second direction, a second coil configured to receive power from a wireless power transmission device and having a ring shape with an outer diameter larger than the first coil when viewed from the second direction, a third coil configured to transmit power to the external electronic device or receive power from the wireless power transmission device and having a ring shape surrounding an outer peripheral surface of the second coil when viewed from the second direction, wherein the first coil and the second coil are electrically connected in parallel, and the third coil is electrically connected in series with the first coil and the second coil.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2 is a front perspective view illustrating an electronic device according to an embodiment of the disclosure;

FIG. 3 is a rear perspective view illustrating an electronic device according to an embodiment of the disclosure;

FIG. 4 is a front exploded perspective view illustrating an electronic device according to an embodiment of the disclosure;

FIG. 5 is a rear exploded perspective view illustrating an electronic device according to an embodiment of the disclosure;

FIG. 6 is a view illustrating an electronic device, a wireless power transmission device, and an external electronic device according to an embodiment of the disclosure;

FIG. 7 is a view illustrating a coil assembly and an equivalent circuit diagram thereof according to an embodiment of the disclosure;

FIG. 8 is a view illustrating a cross-sectional view and a plan view illustrating a coil assembly according to an embodiment of the disclosure;

FIG. 9 is a view illustrating a cross-sectional view and a plan view illustrating a coil assembly according to an embodiment of the disclosure;

FIG. 10 is a view illustrating a cross-sectional view illustrating a coil assembly and a shielding member according to an embodiment of the disclosure;

FIG. 11 is a graph illustrating inductance according to thickness of a shielding member according to an embodiment of the disclosure;

FIG. 12 is a view illustrating a cross-sectional view illustrating a shielding member according to an embodiment of the disclosure;

FIG. 13 is a view illustrating a cross-sectional view illustrating a coil assembly and a shielding member according to an embodiment of the disclosure;

FIG. 14A is a view illustrating a cross-sectional view and an equivalent circuit diagram illustrating a coil assembly according to an embodiment of the disclosure;

FIG. 14B is a view illustrating a cross-sectional view and an equivalent circuit diagram illustrating a coil assembly according to an embodiment of the disclosure;

FIG. 14C is a view illustrating a cross-sectional view and an equivalent circuit diagram illustrating a coil assembly according to an embodiment of the disclosure;

FIG. 14D is a view illustrating a cross-sectional view and an equivalent circuit diagram illustrating a coil assembly according to an embodiment of the disclosure;

FIG. 15 is a view illustrating a plan view and an equivalent circuit diagram illustrating a coil assembly according to an embodiment of the disclosure; and

FIG. 16 is a view illustrating a portion of a coil assembly and an external coil according to an embodiment of the disclosure.

Throughout the drawings, like reference numerals will be understood to refer like parts, components, and structures.

### MODE FOR THE INVENTION

The following description with reference to the accompanying drawings is provided to assist in a comprehensive understanding of various embodiments of the disclosure as defined by the claims and their equivalents. It includes various specific details to assist in that understanding, but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the disclosure. Accordingly, it should be apparent to those skilled in the art that the following description of various embodiments of the disclosure is provided for illustration purposes only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

A wireless charging system of an electronic device adopts a parallel coil structure that performs two functions. The wireless charging system of the electronic device may perform a function as a Radio Receiver (Rx) that charges the electronic device by receiving power from a wireless power transmission device, and may perform a function as a Radio Transmitter (Tx) that transmits power to and charges an external electronic device (e.g., a smart watch or wireless earphones) by utilizing the electronic device as a charger.

An Rx coil of the electronic device is configured as a wireless power consortium (WPC) coil with an outer diameter of about 40-45 mm according to international standards, and the Rx coil of the electronic device may charge the electronic device by receiving power from a wireless power transmission device.

Further, an external electronic device (e.g., a smart watch or wireless earphones) generally uses a small coil with an outer diameter of 30 mm or less, rather than applying a large-sized coil like the WPC coil.

Since the electronic device and the external electronic device utilize coils of different sizes, when the electronic device is utilized as a charger for charging the external electronic device, a problem may occur where the coupling coefficient (k) between the two coils is lowered due to the size difference between the Rx coil inside the electronic device and the Tx coil inside the external electronic device, resulting in decreased charging efficiency.

To address this issue, a charging coil of the electronic device may be configured to operate as a single coil by connecting a WPC coil for receiving power from a wireless power transmission device and a Share coil for transmitting power to an external electronic device in parallel.

For charging efficiency in such a parallel coil structure, physical and electrical design methods that may increase the inductance value of the coil and lower the resistance are needed.

An embodiment of the disclosure provides an electronic device that provides an enhanced usage environment by at least resolving the above-described problems and/or disadvantages and at least providing the advantages described below.

An embodiment of the disclosure may increase the charging efficiency of the WPC coil and the Share coil by connecting an additional coil, which may receive power from a wireless power transmission device and transmit power to an external electronic device, in series with the WPC coil and the Share coil.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

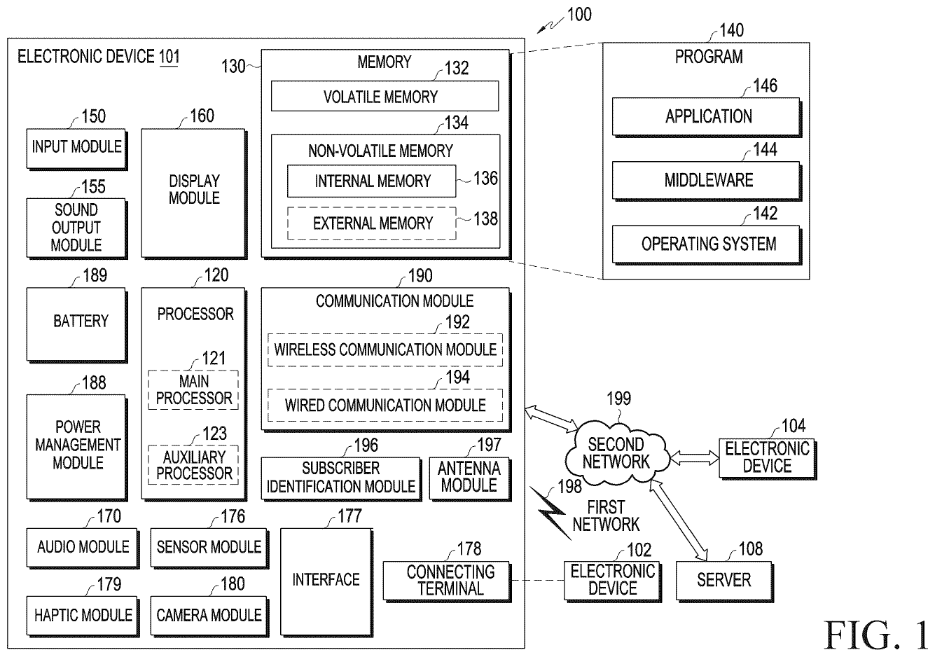

FIG. 1 is a block diagram illustrating an electronic device 101 in a network environment 100 according to an embodiment of the disclosure.

Referring to FIG. 1, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., the program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operation state (e.g., power or temperature) of the electronic device 101 or an external environmental state (e.g., the user's state), and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wiredly) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a fifth generation (5G) network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or user plane (U-plane) latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to an embodiment of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

An embodiment of the disclosure may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities. Some of the plurality of entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

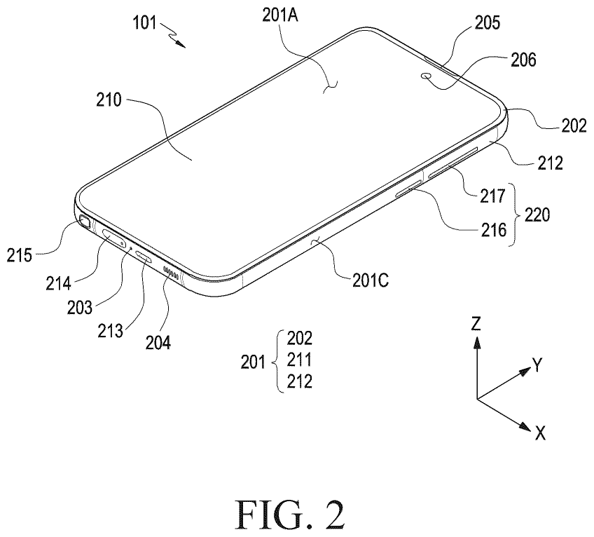

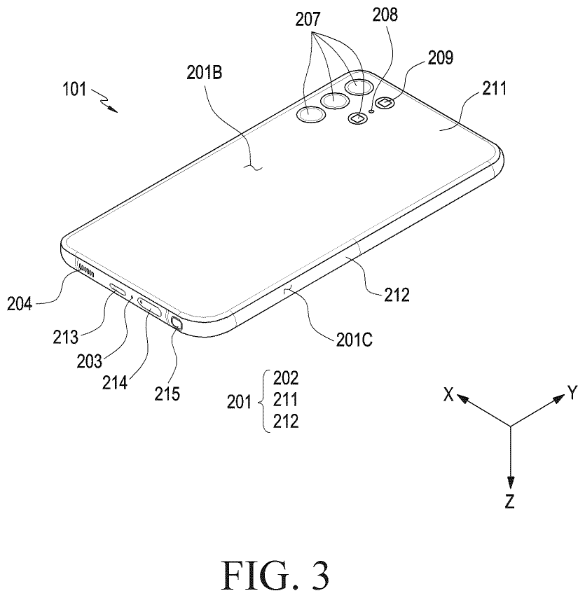

FIG. 2 is a front perspective view illustrating an electronic device 101 according to an embodiment of the disclosure. FIG. 3 is a rear perspective view illustrating an electronic device 101 according to an embodiment of the disclosure.

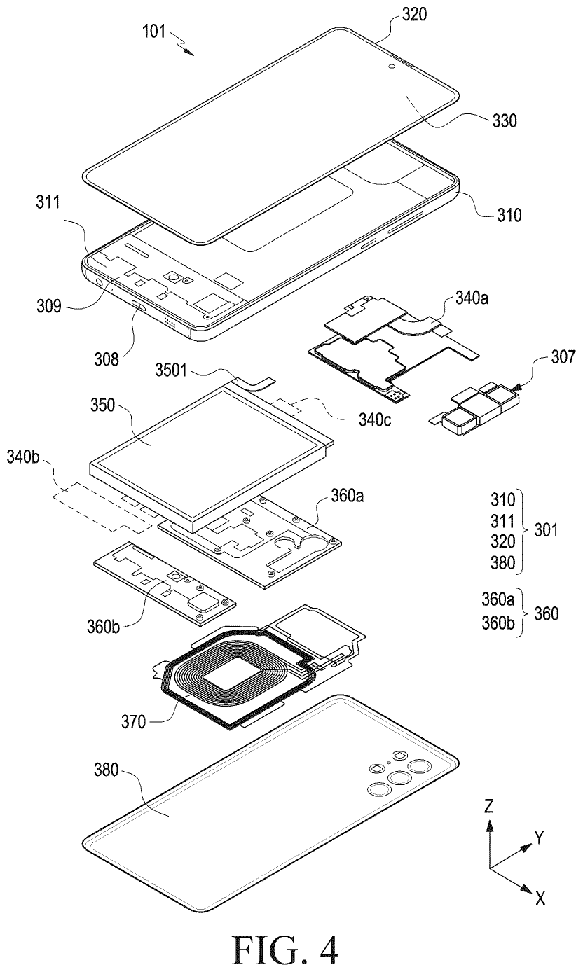

Referring to FIGS. 2 and 3, the illustrated embodiments may be combined with the embodiments of FIGS. 4 to 13, 14A to 14D, 15, and 16.

The components described with reference to FIGS. 2 and 3 may be identical in whole or part to the components described with reference to FIGS. 4 to 13, 14A to 14D, 15, and 16.

In the following detailed description, a length direction, a width direction, and/or a thickness direction (or height direction) of the electronic device may be mentioned and may be defined as a ‘Y-axis direction,’ ‘X-axis direction’, and/or ‘Z-axis direction,’ respectively. In an embodiment, ‘negative/positive (−/+)’ may be mentioned together with the Cartesian coordinate system exemplified in the drawings with respect to the direction in which the component is oriented.

For example, the front surface of the electronic device and/or housing may be defined as a ‘surface facing in the +Z direction,’ and the rear surface or back surface may be defined as a ‘surface facing in the −Z direction’. In an embodiment, the side surface of the electronic device and/or housing may include an area facing in the +X direction, an area facing in the +Y direction, an area facing in the −X direction, and/or an area facing in the −Y direction. In an embodiment, the ‘X-axis direction’ may mean including both the ‘−X direction’ and the ‘+X direction’.

Hereinafter, in the following description of the electronic device 101, ‘first direction’ may mean the −Z-axis direction (or a direction parallel to the −Z axis), and ‘second direction’ may mean the +Z-axis direction (or a direction parallel to the +Z axis).

Hereinafter, in the description of the electronic device 101, when a component is ‘disposed on’ another component, it may mean that the component is disposed in the +Z direction with respect to the other component. It should be noted that the directions are so defined with respect to the Cartesian coordinate system shown in the drawings for the sake of brevity of description, and the description of these directions or components do not limit an embodiment(s) of the disclosure. For example, the Cartesian coordinate system may be defined as different from that disclosed in the disclosure depending on the specifications of the electronic device or the user's usage habits.

Referring to FIGS. 2 and 3, an electronic device 101 may include a housing 201 with a front surface 201A, a rear surface 201B, and a side surface 201C surrounding a space between the front surface 201A and the rear surface 201B. The housing 201 may denote a structure forming part of the front surface 201A, the rear surface 201B, and the side surface 201C of FIG. 2. At least part of the front surface 201A may have a substantially transparent front plate 202 (e.g., a glass plate or polymer plate including various coat layers). The rear surface 201B may be formed by a rear plate 211. The rear plate 211 may be formed of a material such as glass, ceramic, polymer, metal (e.g., aluminum, stainless steel (STS), or magnesium), or a combination of at least two thereof. The side surface 201C may be formed by a side bezel structure (or a “side member”) 212 that couples to the front plate 202 and the rear plate 211 and includes a metal and/or polymer. In an embodiment, the front plate 202 and side bezel structure 212 may be formed as one body and may include the same material. According to another embodiment, the rear plate 211 and the side bezel structure 212 may be integrally formed together and include the same material (e.g., glass, metal, such as aluminum, or ceramic). The front surface 201A and/or the front plate 202 may be interpreted as a part of the display 210 (e.g., the display module 160 of FIG. 1). The housing 201 may include the front plate 202 and the rear plate 211.

The electronic device 101 may include at least one of a display 210, audio modules 203, 204, and 205 (e.g., the audio module 170 of FIG. 1), a sensor module (e.g., the sensor module of FIG. 1). 176), camera modules 206 and 207 (e.g., the camera module 180 of FIG. 1), a key input device 216 or 217 (e.g., the input module 150 of FIG. 1), and connector holes 213 and 214 (e.g., the connection terminal 178 of FIG. 1). According to embodiments of the disclosure, at least one (e.g., the connector hole 214) of the components may be omitted or other components may be added.

The display 210 may be viewable through, e.g., a majority portion of the front plate 202. At least a portion of the display 210 may be exposed through the front plate 202 forming the front surface 202A. According to an embodiment of the disclosure, the display 210 may be a flexible display or a foldable display.

The surface (or the front plate 202) of the housing 201 may include a screen display area formed as the display 210 is visually exposed. For example, the screen display area may include the front surface 201A.

The electronic device 101 may include a recess or opening (not shown) formed in a portion of the screen display area (e.g., the front surface 201A) of the display 210 and may include at least one or more of an audio module 205, a sensor module (not shown), a light emitting device (not shown), and a camera module 206 aligned with the recess or opening. At least one or more of the audio module 205, sensor module (not shown), camera module 206, fingerprint sensor (not shown), and light emitting device (not shown) may be included on the rear surface of the screen display area of the display 210.

The display 210 may be disposed to be coupled with, or adjacent, a touch detecting circuit, a pressure sensor capable of measuring the strength (pressure) of touches, and/or a digitizer for detecting a magnetic field-type pen input device 215 (e.g., stylus pen).

At least a portion of the key input device 216 or 217 may be disposed on the side bezel structure 212.

The audio modules 203, 204, and 205 may include, e.g., a microphone hole 203 and speaker holes 204 and 205. A microphone for acquiring external sounds may be disposed in the microphone hole 203. A plurality of microphones may be disposed to detect the direction of the sound. The speaker holes 204 and 205 may include an external speaker hole 204 and a phone receiver hole 205. The speaker holes 204 and 205 and the microphone hole 203 may be implemented as a single hole, or speakers may be rested without the speaker holes 204 and 205 (e.g., piezo speakers). The audio modules 203, 204, and 205 are not limited to the above-described structure. Depending on the structure of the electronic device 101, various design changes may be made; for example, only some of the audio modules may be mounted, or a new audio module may be added.

The sensor modules (not shown) may generate an electrical signal or data value corresponding to an internal operating state or external environmental state of the electronic device 101. The sensor modules (not shown) may include a first sensor module (not shown) (e.g., a proximity sensor) and/or a second sensor module (not shown) (e.g., a fingerprint sensor) disposed on the front surface 201A of the housing 201 and/or a third sensor module (not shown) (e.g., a heart rate monitor (HRM) sensor) and/or a fourth sensor module (not shown) (e.g., a fingerprint sensor) disposed on the rear surface 201B of the housing 201. The fingerprint sensor may be disposed on the rear surface 201B as well as on the front surface 201A (e.g., the display 210) of the housing 201. The electronic device 101 may further include additional sensor modules, such as at least one of a gesture sensor, a gyro sensor, an atmospheric pressure sensor, a magnetic sensor, an acceleration sensor, a grip sensor, a color sensor, an infrared (IR) sensor, a biometric sensor, a temperature sensor, a humidity sensor, or an illuminance sensor (not shown). The sensor module (not shown) is not limited to the above-described structure. Depending on the structure of the electronic device 101, various design changes may be made; for example, only some of the sensor modules may be mounted, or a new sensor module may be added.

The camera modules 206 and 207 may include a front camera module 206 disposed on the front surface 201A of the electronic device 101 and a rear camera module 207, a flash 208, and/or an IR sensor 209 disposed on the rear surface 201B. The camera modules 206 and 207 may include one or more lenses, an image sensor, and/or an image signal processor. The flash 208 may include, e.g., a light emitting diode (LED) or a xenon lamp. The camera modules 206 and 207 are not limited to the above-described structure. Depending on the structure of the electronic device 101, various design changes may be made; for example, only some of the camera modules may be mounted, or a new camera module may be added.

The electronic device 101 may include a plurality of camera modules (e.g., a dual camera or triple camera) having different attributes (e.g., angle of view) or functions. For example, the rear camera module 207 may include a plurality of camera modules including lenses with different fields of view. For example, the plurality of camera modules may include at least one of a wide-angle camera, an ultra wide-angle camera, a telephoto camera, and an infrared (IR) camera (e.g., a time of flight (TOF) camera, a structured light camera). The plurality of camera modules may include optical zoom cameras with adjustable magnification. The electronic device 101 may be configured to operate a designated camera module or another camera module, based on the user's selection, or under a predetermined environment, for the plurality of camera modules. The IR camera may be operated as at least a portion of the sensor module. For example, the TOF camera may be operated as at least a portion of a sensor module (not shown) for detecting the distance to the subject. The front camera module 206 may be implemented as an under display camera (UDC) module.

Key input devices 216, 217 (e.g., volume keys) may be disposed on a side surface 201C of the housing 201. The electronic device 101 may not include some or all of the above-described key input devices 216, 217, and the key input devices 216, 217 omitted may be implemented in other forms such as soft keys on the display 210. According to an embodiment of the disclosure, the key input device 216 or 217 may include a sensor module (not shown) disposed on the rear surface 210B of the housing 201.

The light emitting device may be disposed on, for example, the front surface 201A of the housing 201. The light emitting device (not illustrated) may provide, for example, information about the state of the electronic device 101 in the form of light. In an embodiment, the light emitting device (not shown) may provide a light source that interacts with, for example, the front camera module 206. The light emitting device (not shown) may include, for example, a light emitting diode (LED), an infrared (IR) LED, and/or a xenon lamp.

The connector holes 213 and 214 may include a first connector hole 213 for receiving a connector (e.g., an earphone jack) for transmitting/receiving audio signals to/from an external electronic device or a connector (e.g., a USB connector) for transmitting/receiving power and/or data to/from the external electronic device and/or a second connector hole 214 for receiving a storage device (e.g., a subscriber identification module (SIM) card, a secure digital (SD) memory card). The first connector hole 213 and/or the second connector hole 214 may be omitted. The connector holes 213 and 214 are not limited to the above-described structure. Depending on the structure of the electronic device 101, various design changes may be made, such as mounting only some of the connector holes or adding a new connector hole.

The pen input device 215 (e.g., a stylus pen) may be guided and detachably inserted through a hole formed in a side surface of the housing 201 into the inside of the housing 201. The pen input device 215 may include a button for easy detachment. A separate resonant circuit may be embedded in the pen input device 215 and may interwork with an electromagnetic induction panel (e.g., a digitizer) included in the electronic device 101. The pen input device 215 may be implemented in an electro-magnetic resonance (EMR), active electrical stylus (AES), or electric coupled resonance (ECR) scheme.

The camera module 206, 207 and/or the sensor module (not shown) may be disposed to contact the external environment through a designated area of the display 210 and the front plate 202 from the internal space of the electronic device 101. For example, the designated area may be an area in which pixels are not disposed in the display 210. As another example, the designated area may be an area in which pixels are disposed in the display 210. When viewed from above the display 210, at least a portion of the designated area may overlap the camera module 206, 207 and/or the sensor module. As another example, some sensor modules may be arranged to perform their functions without being visually exposed through the front plate 202 from the internal space of the electronic device.

The electronic device 101 disclosed in FIGS. 2 and 3 has a bar-type or plate-type appearance but the disclosure is not limited thereto. For example, the illustrated electronic device may be part of a rollable electronic device or a foldable electronic device. “Rollable electronic device” may mean an electronic device at least a portion of which may be wound or rolled or received in a housing (e.g., the housing 201 of FIG. 2) as the display may be bent and deformed. As the display is stretched out or is exposed to the outside in a larger area according to the user's need, the rollable electronic device may use an expanded second display area. “Foldable electronic device” may mean an electronic device that may be folded in directions to face two different areas of the display or in directions opposite to each other. In general, in the portable state, the foldable electronic device may be folded so that the two different areas of the display face each other and, in an actual use state, the user may unfold the display so that the two different areas form a substantially flat shape. In an embodiment, the electronic device 101 according to an embodiment of the disclosure may be interpreted as including various electronic devices, such as a laptop computer or a home appliance, as well as a portable electronic device, such as a smart phone.

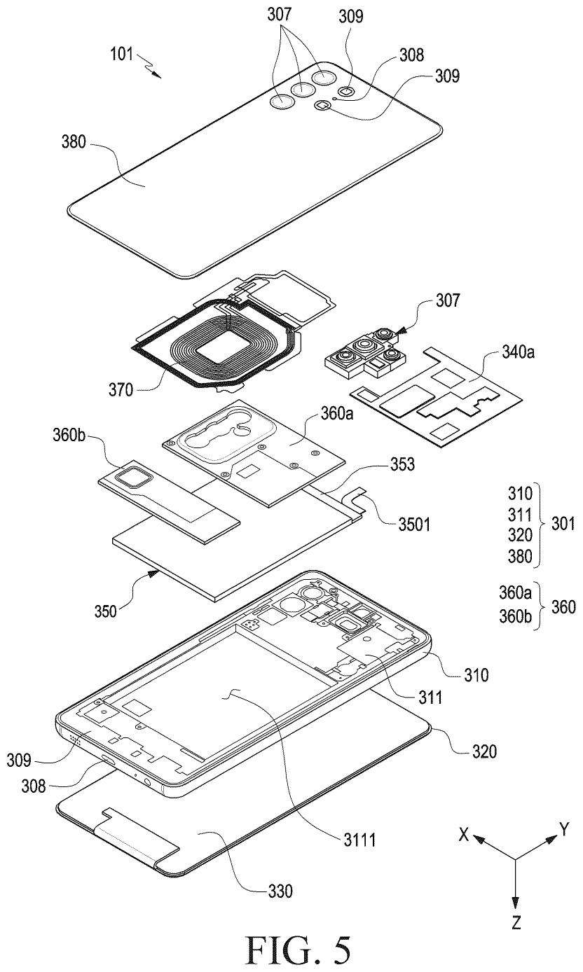

FIG. 4 is a front exploded perspective view illustrating an electronic device according to an embodiment of the disclosure. FIG. 5 is a rear exploded perspective view illustrating an electronic device according to an embodiment of the disclosure.

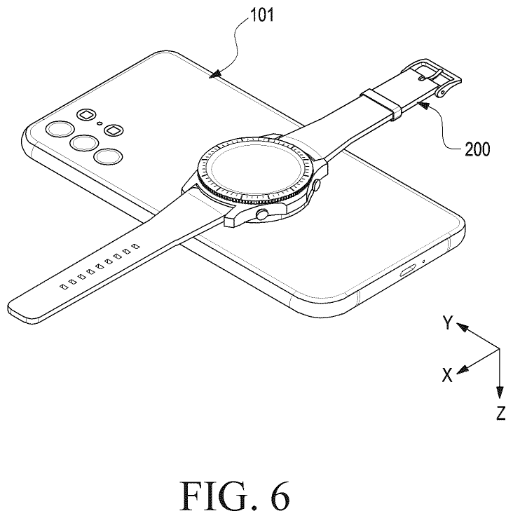

The embodiments of FIGS. 4 and 5 may be combined with the embodiments of FIGS. 1 to 3 or the embodiments of FIGS. 6 to 13, 14A to 14D, 15, and 16.

Some or all of the components described with reference to FIGS. 4 and 5 may be the same as those described with reference to FIGS. 1 to 3. Some or all of the components described with reference to FIGS. 4 and 5 may be the same as those described with reference to FIGS. 6 to 13, 14A to 14D, 15, and 16.

Referring to FIGS. 4 and 5, an electronic device 101 (e.g., the electronic device 101 of FIG. 2 or 3) may include a side structure 310, a first support member 311 (e.g., a bracket), a front plate 320 (e.g., the front plate 202 of FIG. 2), a display 330 (e.g., the display 210 of FIG. 1), at least one printed circuit board (or a board assembly) 340a or 340b, a battery 350, a second support member 360 (e.g., a rear case), an antenna, a camera assembly 307, and a rear plate 380 (e.g., the rear plate 211 of FIG. 3). When a plurality of printed circuit boards 340a and 340b are included, the electronic device 101 may electrically connect different printed circuit boards by at least one flexible printed circuit board 340c. For example, the printed circuit boards 340a, 340b may include a first circuit board 340a disposed above the battery 350 (e.g., in the +Y-axis direction) and a second circuit board 340b disposed below (e.g., in the −Y-axis direction), and the flexible printed circuit board 340c may electrically connect the first circuit board 340a and the second circuit board 340b.

The at least one component (e.g., the first support member 311 or the second support member 360) may be omitted or other components may be added. At least one of the components of the electronic device 101 may be the same or similar to at least one of the components of the electronic device 101 of FIG. 1 or 2 and no duplicate description is made below.

At least a portion of the first support member 311 may be provided in a flat plate shape. The first support member 311 may be disposed inside the electronic device 101 to be connected with the side structure 310 or integrated with the side structure 310. The first support member 311 may be formed of a metallic material and/or non-metallic material (e.g., polymer). When the first support member 311 is at least partially formed of a metallic material, a portion of the side structure 310 or the first support member 311 may function as an antenna. The display 330 may be joined onto one surface of the first support member 311, and the printed circuit boards 340a and 340b may be joined onto the opposite surface of the first support member 311. A processor, memory, and/or interface may be mounted on the printed circuit boards 340a and 340b. The processor may include one or more of a central processing unit, an application processor, a graphic processing device, an image signal processing, a sensor hub processor, or a communication processor.

The housing 301 may include a first support member 311 and a side structure 310. The housing 301 may be understood as a structure for receiving, protecting, or disposing the printed circuit boards 340a and 340b or the battery 350. The housing 301 may be understood as including a structure that the user may visually or tactfully recognize from the outside of the electronic device 101, e.g., the side structure 310, the front plate 320, and/or the rear plate 380. For example, the housing 301 may include structures (e.g., the side structure 310, the front plate 320, and the rear plate 380) forming the appearance of the electronic device 101. The housing 301 may be identical to the housing 201 described in connection with FIGS. 2 and 3. The ‘front or rear surface of the housing 301’ may refer to the first surface 210A of FIG. 1 or the second surface 210B of FIG. 2. The first support member 311 may be disposed between the front plate 320 (e.g., the first surface 210A of FIG. 2) and the rear plate 380 (e.g., the second surface 210B of FIG. 3) and may function as a structure for placing an electrical/electronic component, such as the printed circuit boards 340a and 340b or the camera assembly 307.

The memory may include volatile or non-volatile memory.

The interface may include a high definition multimedia interface (HDMI), a universal serial bus (USB) interface, a secure digital (SD) card interface, and/or an audio interface. The interface may electrically or physically connect, e.g., the electronic device 101 with an external electronic device and may include a USB connector, an SD card/multimedia card (MMC) connector, or an audio connector.

The second support member 360 may include an upper support member 360a or a lower support member 360b. The upper support member 360a, together with a portion of the first support member 311, may be disposed to surround the printed circuit boards 340a and 340b (e.g., the first circuit board 340a). For example, the upper support member 360a of the second support member 360 may be disposed to face the first support member 311 with the first circuit board 340a interposed therebetween. The lower support member 360b of the second support member 360 may be disposed to face the first support member 311 with the second circuit board 340b interposed therebetween. A circuit device (e.g., a processor, a communication module, or memory) implemented in the form of an integrated circuit chip or various electrical/electronic components may be disposed on the printed circuit boards 340a and 340b. The printed circuit boards 340a and 340b may receive an electromagnetic shielding environment from the second support member 360. The lower support member 360b may be utilized as a structure in which electrical/electronic components, such as a speaker module, or an interface (e.g., a USB connector, an SD card/MMC connector, or an audio connector) may be disposed. Electrical/electronic components, such as a speaker module and an interface (e.g., a USB connector, an SD card/MMC connector, or an audio connector) may be disposed on an additional printed circuit board (not shown). For example, the lower support member 360b, together with the other part of the first support member 311, may be disposed to surround the additional printed circuit board (e.g., the second flexible printed circuit board 340b). An additional printed circuit board (not illustrated) or a speaker module or interface disposed on the lower support member 360b may be disposed corresponding to the audio modules 203, 204, 205 or the connector holes 213, 214 of FIG. 2.

At least a portion of the support member 360 may be provided in a flat plate shape. The support member 360 may be disposed inside the electronic device 101 to be connected with the side surface structure 310 or integrated with the side surface structure 310. The support member 360 may be formed of, e.g., a metal and/or non-metallic material (e.g., polymer).

The battery 350 may be a device for supplying power to at least one component of the electronic device 101. The battery 350 may include a primary cell which is not rechargeable, a secondary cell which is rechargeable, or a fuel cell. At least a portion of the battery 350 may be disposed on substantially the same plane as the printed circuit boards 340a and 340b. The battery 350 may be integrally or detachably disposed inside the electronic device 101.

Although not shown, the antenna may include a conductor pattern implemented on the surface of the second support member 360 through, e.g., laser direct structuring. In an embodiment, the antenna may include a printed circuit pattern formed on the surface of the thin film. The thin film-type antenna may be disposed between the rear plate 380 and the battery 350. The antenna may include, e.g., a near-field communication (NFC) antenna, a wireless charging antenna, and/or a magnetic secure transmission (MST) antenna. The antenna may perform short-range communication with, e.g., an external device or may wirelessly transmit or receive power necessary for charging. In an embodiment of the disclosure, another antenna structure may be formed by a portion or combination of the side structure 310 and/or the first support member 311.

The camera assembly 307 may include at least one camera module. Inside the electronic device 101, the camera assembly 307 (or at least one camera module) may receive at least a portion of the light incident through the optical hole or camera windows. The camera assembly 307 may be disposed on the first support member 311 in a position adjacent to the printed circuit boards 340a and 340b. The camera module(s) of the camera assembly 307 may be generally aligned with either one of the camera windows and be a least partially surrounded by the second support member 360 (e.g., the upper support member 360a).

The electronic device 101 may include camera holes. The plurality of camera holes 312, 313, and 319 may be disposed to be spaced apart from each other. The camera assembly 307 may receive light passing through the camera holes.

According to an embodiment, the first support member 311 may include an accommodation portion 3111. The battery 350 may be disposed in the accommodation portion 3111. The battery 350 may include a terrace 353. The terrace 353 may protrude toward the printed circuit board 340. The battery 350 may include a battery connection member 3501 connecting the terrace 353 and the printed circuit board 340.

The electronic device 101 may include a port insertion opening 308. The port insertion opening 308 may be opened in a portion of the housing 301. The port insertion opening 308 may communicate with the external space of the housing 301. The electronic device 101 may be connected to an external device (e.g., a USB port, a charging cable), and the external device may be inserted into the port insertion opening 308.

The electronic device 101 may include an antenna 309. The antenna 309 may be disposed at a position adjacent to the port insertion opening 308.

The electronic device 101 may further include a coil assembly 370. The coil assembly 370 may charge the electronic device 101 by receiving power from a wireless power transmission device, or charge an external electronic device by transmitting power from the electronic device 101 to the external electronic device.

The coil assembly 370 may transmit power according to an inductive method. When the coil assembly 370 operates by the inductive method, the coil assembly 370 may include at least one of a power source, a direct current-direct current (DC-DC) conversion circuit (e.g., a DC/DC converter), a direct current-alternating current (DC-AC) conversion circuit (e.g., an inverter), an amplification circuit, an impedance matching circuit, at least one capacitor, at least one coil, or a communication modulation circuit. For example, the at least one capacitor may form a resonance circuit together with the at least one coil. For example, the coil means an antenna for transmitting and/or receiving wireless power, and is not limited to an antenna formed in a coil shape.

The coil assembly 370 may be implemented in a manner defined in the Qi standard of the wireless power consortium (WPC). The coil assembly 370 may include a coil that may generate an induced magnetic field when current flows according to the inductive method. The process in which the coil assembly 370 generates an induced magnetic field may be represented as the coil assembly 370 transmitting power wirelessly. Further, in the coil of the coil assembly 370, induced electromotive force (or current, voltage, and/or power) may be generated by a magnetic field generated in the surroundings. The process in which induced electromotive force is generated through the coil may be represented as the coil assembly 370 receiving power wirelessly.

According to an embodiment of the disclosure, the coil assembly 370 may be disposed adjacent to the rear plate 380 in the second direction. According to another embodiment, the coil assembly 370 may be disposed on the front surface (e.g., in the +Z-axis direction) of the rear plate 380. When the coil assembly 370 is disposed adjacent to the rear plate 380, charging efficiency may increase as the coil assembly 370 is disposed adjacent to the external electronic device and/or the wireless power transmission device when transmitting power to the external electronic device and/or receiving power from the wireless power transmission device.

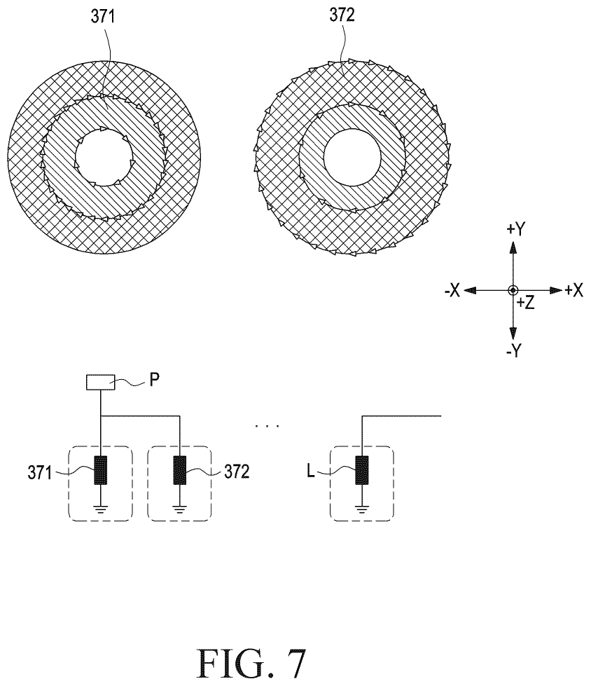

FIG. 6 is a view illustrating an electronic device and an external electronic device according to an embodiment of the disclosure. FIG. 7 is a view illustrating a coil assembly and an equivalent circuit diagram thereof according to an embodiment of the disclosure.

Referring to FIGS. 6 and 7, the illustrated embodiments may be combined with the embodiments of FIGS. 1 to 5 or FIGS. 8 to 13, 14A to 14D, 15, and 16.

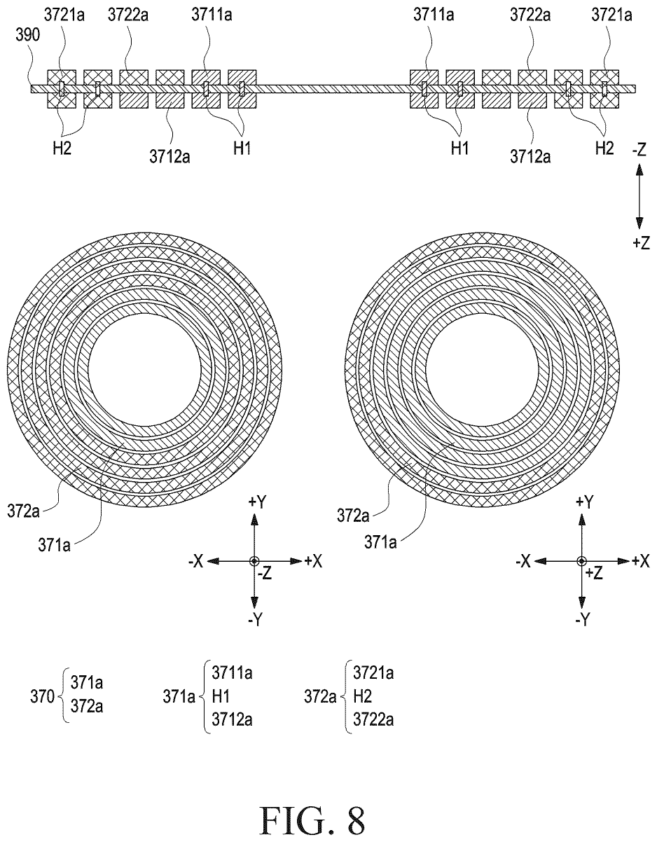

The components described with reference to FIGS. 6 and 7 may be identical in whole or part to the components described with reference to FIGS. 1 to 5. The components described with reference to FIGS. 6 and 7 may be identical in whole or part to the components described with reference to FIGS. 8 to 13, 14A to 14D, 15, and 16.

Referring to FIG. 6, the electronic device 101 may charge the external electronic device 200. However, the size of the above-described coil assembly (e.g., the coil assembly 370 of FIG. 5) inside the electronic device 101 and the size of the external coil L disposed in the external electronic device 200 may be different.

For example, the external electronic device 200 may use a relatively small-sized wireless charging coil (e.g., the external coil L of FIG. 7) due to product size and internal structural constraints. Generally, the wireless charging coil inside the coil assembly (e.g., the coil assembly 370 of FIG. 5) of the electronic device 101 has an outer diameter of about 40-45 mm according to international standards, but the external electronic device 200 has limited inner space, so a small external coil L with an outer diameter of 30 mm or less is applied.

Further, a light weight may be essential for the external electronic device 200, and accordingly, the wireless charging coil also needs to be designed to be light and thin. Applying a large coil may lead to constraints in battery and internal component placement, resulting in increased product thickness and weight. Therefore, it may be necessary to use a small-sized external coil L that enables efficient power transmission even in limited inner space.

Further, by applying the small-sized external coil L, alignment issues on the wireless power supply device may be minimized. The external electronic device 200 may be disposed at various angles on the wireless power transmission device, and if an excessively large coil is used, there is a possibility that charging efficiency will decrease due to misalignment with the charging area. Accordingly, it is preferable to facilitate charging alignment by applying an appropriately sized external coil L.

Further, since the external electronic device 200 requires relatively low power, charging using a large-sized external coil L may be inefficient. Generally, charging of the external electronic device 200 is possible with a power value smaller than the wireless charging power of the electronic device 101. Therefore, the external electronic device 200 may utilize a small-sized external coil L considering power consumption and charging efficiency.

Due to the size difference between the coil inside the electronic device 101 and the external coil L of the external electronic device 200, when the electronic device 101 is utilized as a charger for charging the external electronic device 200, a problem may occur where the coupling coefficient (k) between the two coils is lowered, resulting in decreased efficiency. To address this issue, the coil assembly 370 of the electronic device 101 may be configured to operate as a single coil by connecting the first coil 371 and the second coil 372 of different sizes in parallel.

Referring to FIG. 7, the first coil 371 and the second coil 372 may be configured to receive power transmitted from a single power supply device P in parallel. The amount of power received by the first coil 371 and the second coil 372 may vary according to the user's usage environment and usage method.

In this illustration and the following embodiments, an example is described in which the outer diameter of the first coil 371 when viewed from the second direction is 30 mm or less, and the outer diameter of the second coil 372a is 40 mm or more and 45 mm or less, but this is not limited thereto, and the outer diameters of the first coil 371 and the second coil 372 may be changed in the future according to the design of the electronic device and the external electronic device.

Referring to FIG. 7, the electronic device 101 may utilize the first coil 371 to transmit power to the external electronic device 200. The first coil 371 may be referred to as a ‘transmitting coil (Tx coil)’ or a ‘share coil’.

The first coil 371 plays a role of transmitting power to the external electronic device 200 when the electronic device 101 is utilized as a charger, i.e., when the electronic device 101 transmits power to the external electronic device 200. When current flows through the first coil 371, it may form a magnetic field due to the current and wirelessly transmit power to the external electronic device 200, and may be designed with a structure having a high coupling coefficient (k) for efficient power transmission.

Referring to FIG. 7, the electronic device 101 may utilize the second coil 372 to receive power from a wireless power transmission device. The second coil 372 may be referred to as an ‘receiving coil (Rx coil)’ or a ‘wireless power consortium coil (WPC coil)’.

In the electronic device 101, the second coil 372 may perform a function of charging an internal battery by receiving power induced through a magnetic field from the external coil L disposed in the wireless power transmission device. The design of the second coil 372 is configured to have high inductance for efficient power reception, and may be disposed considering the coupling coefficient with the external coil L disposed in the external electronic device 200. The second coil may have an outer diameter of 40-45 mm and may be configured to enable stable power reception when an electronic device 101 such as a smartphone is wirelessly charged.

The first coil 371 may be connected in parallel with the second coil 372 to operate as a single coil. The first coil 371 may be designed to increase the coupling coefficient with the external electronic device 200 having a small outer diameter. Accordingly, the electronic device 101 may more efficiently charge the external electronic device 200 such as a smart watch or wireless earphones.

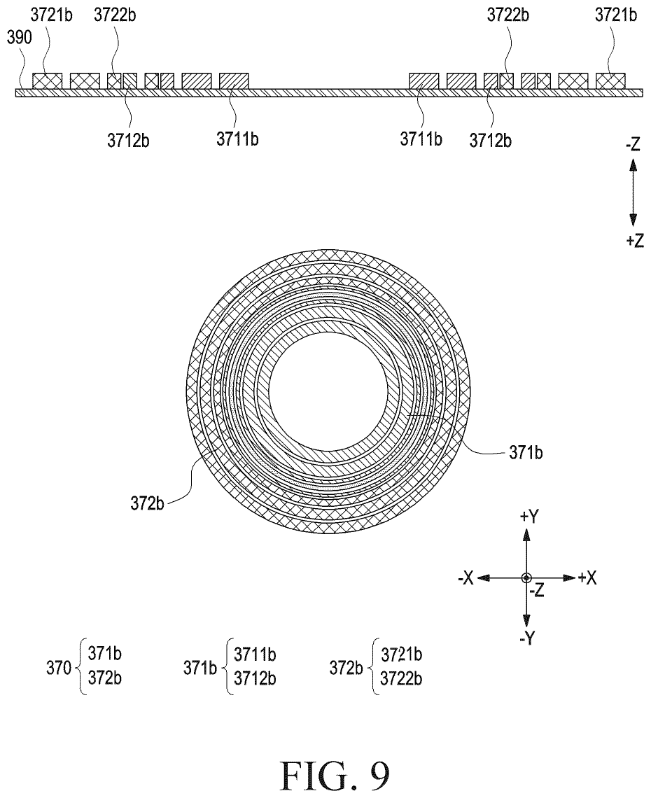

FIG. 8 is a view illustrating a cross-sectional view and a plan view illustrating a coil assembly according to an embodiment of the disclosure. FIG. 9 is a view illustrating a cross-sectional view and a plan view illustrating a coil assembly according to an embodiment of the disclosure.

Referring to FIGS. 8 and 9, the illustrated embodiments may be combined with the embodiments of FIGS. 1 to 7 or FIGS. 10 to 13, 14A to 14D, 15, and 16.

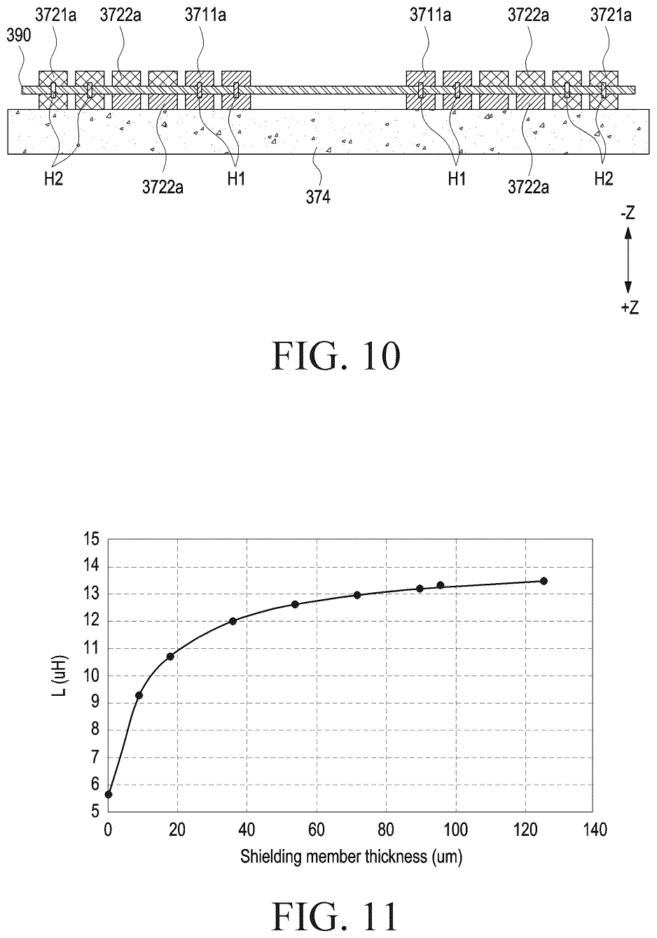

Some or all of the components described with reference to FIGS. 8 and 9 may be the same as those described with reference to FIGS. 1 to 7. Some or all of the components described with reference to FIGS. 7 to 9 may be the same as all or some of the components described with reference to FIGS. 10 to 13, 14A to 14D, 15, and 16.

According to FIGS. 8 and 9, the coil assembly 370 may include various parallel coil structures. FIGS. 8 and 9 illustrate the arrangement structure when the first coil 371 and the second coil 372 are connected in parallel to enhance efficiency.

Referring to FIG. 8, based on the support member 390, the first coil 371a and the second coil 372a may be disposed in the first direction (e.g., −Z-axis direction) and the second direction (e.g., +Z-axis direction), and the coil disposed in the first direction (e.g., −Z-axis direction) and the coil disposed in the second direction (e.g., +Z-axis direction) may each be connected to different printed circuit boards to receive power.

In this case, since the coils inside the coil assembly 370 are physically separated by the support member 390 and connected to different printed circuit boards, the first coil 371a and the second coil 372a may be connected in parallel to the above-described power supply device (e.g., the power supply device of FIG. 7).

Further, as is described below, by additionally disposing holes (e.g., the first hole H1, the second hole H2) in the support member 390 when viewed from the second direction (e.g., +Z-axis direction), the coil disposed in the first direction (e.g., −Z-axis direction) and the coil disposed in the second direction (e.g., +Z-axis direction) may be connected to operate as a single coil.

Referring to FIG. 8, when the first coil 371a and the second coil 372a are both disposed in the first direction (e.g., −Z-axis direction) and the second direction (e.g., +Z-axis direction) of the support member 390 and connected in parallel, the first coil 371a may have a ring shape when viewed from the second direction, and the second coil 372a may have a ring shape surrounding the outer peripheral surface of the first coil 371a when viewed from the second direction.

The support member 390 may be additionally disposed in the coil assembly 370. The support member 390 may be referred to as a ‘substrate’.

The support member 390 may be a configuration for supporting and disposing the coil assembly 370. Specifically, the support member 390 may be a configuration for enabling the coils of the coil assembly 370 to be stably disposed and connected.

The support member 390 provides a physical structure so that coils may be disposed in the first direction (e.g., −Z-axis direction) and/or the second direction (e.g., +Z-axis direction) of the support member 390, and may form a foundation for interconnection of the coils. Accordingly, the coils may be connected to different printed circuit boards, and connection to the above-described power supply device (e.g., the power supply device P of FIG. 7) becomes possible. The support member 390 may be configured to fix the coils in accurate positions, and may also be a configuration related to arrangement and separation between coils for efficient power transmission.

The support member 390 may have a planar shape perpendicular to the second direction (e.g., +Z-axis direction), overlaps the coil assembly 370 when viewed from the second direction (e.g., +Z-axis direction), is disposed between portions of the coil assembly 370, and may be configured to support the coil assembly 370 from the first direction (e.g., −Z-axis direction) and/or the second direction (e.g., +Z-axis direction).

The first coil 371 may include a (1-1)th coil 3711a and a (1-2)th coil 3712a. The first coil 371 may be configured to form an inner peripheral surface of the coil assembly 370.

Referring to FIG. 8, the (1-1)th coil 3711a is configured to form the inner peripheral surface of the first coil 371a and may be disposed in the first direction (e.g., −Z-axis direction) and the second direction (e.g., +Z-axis direction) of the support member 390. The (1-1)th coil 3711a may be configured to form the inner peripheral surface of the coil assembly 370.

Further, the (1-2)th coil 3712a is disposed in the second direction (e.g., +Z-axis direction) of the support member 390 and may be disposed to surround the outer peripheral surface of the portion disposed in the second direction (e.g., +Z-axis direction) among the (1-1)th coil 3711a when viewed from the second direction (e.g., +Z-axis direction).

In this illustration and the following embodiments, an example is described in which the (1-2)th coil 3712a is disposed in the second direction (e.g., +Z-axis direction) of the support member 390, but this is not limited thereto. For example, if the (1-2)th coil 3712a overlaps the (2-2)th coil 3722a to be described below when viewed from the second direction (e.g., +Z-axis direction), and the (1-2)th coil 3712a and the (2-2)th coil 3722a are disposed in different directions based on the support member 390 and physically separated so that the first coil 371a and the second coil 372a are electrically connected in parallel, the (1-2)th coil 3712a may also be disposed in the first direction (e.g., −Z-axis direction) of the support member 390.

The first hole H1 substantially parallel to the second direction may be formed at a position corresponding to the (1-1)th coil 3711a of the support member 390. Accordingly, electrical separation of the first coil 371a by the support member 390 may be prevented.

Specifically, by forming the first hole H1 in the support member 390, the portion disposed in the first direction (e.g., −Z-axis direction) and the portion disposed in the second direction (e.g., +Z-axis direction) of the (1-1)th coil 3711a may be connected to operate as a single coil.

According to an embodiment, the second coil 372 may include a (2-1)th coil 3721 and a (2-2)th coil 3722.

Referring to FIG. 8, the second coil 372a may include a (2-1)th coil 3721a and a (2-2)th coil 3722a. The second coil 372a may be configured to form the outer peripheral surface of the coil assembly 370.

The (2-1)th coil 3721a is configured to form the outer peripheral surface of the second coil 372a and may be disposed in the first direction (e.g., −Z-axis direction) and the second direction (e.g., +Z-axis direction) of the support member 390. According to an embodiment, the (2-1)th coil 3721a may be configured to form the outer peripheral surface of the coil assembly 370.

Further, the (2-2)th coil 3722a is disposed in the first direction (e.g., −Z-axis direction) of the support member 390 and may be disposed such that the outer peripheral surface is surrounded by the portion disposed in the first direction (e.g., −Z-axis direction) among the (2-1)th coil 3721a when viewed from the second direction (e.g., +Z-axis direction).

In this illustration and the following embodiments, an example is described in which the (2-2)th coil 3722 is disposed in the first direction (e.g., −Z-axis direction) of the support member 390, but this is not limited thereto. For example, as described above, if the (2-2)th coil 3722 overlaps the (1-2)th coil 3712a when viewed from the second direction (e.g., +Z-axis direction), and the (1-2)th coil 3712a and the (2-2)th coil 3722a are disposed in different directions based on the support member 390 and physically separated so that the first coil 371 and the second coil 372 are electrically connected in parallel, the (2-2)th coil 3722 may also be disposed in the second direction (e.g., +Z-axis direction) of the support member 390.

The second hole H2 substantially parallel to the second direction may be formed at a position corresponding to the (2-1)th coil 3721a of the support member 390. Accordingly, electrical separation of the second coil 372a by the support member 390 may be prevented.

Specifically, by forming the second hole H2 in the support member 390, the portion disposed in the first direction (e.g., −Z-axis direction) and the portion disposed in the second direction (e.g., +Z-axis direction) of the (2-1)th coil 3721a may be connected to operate as a single coil.

When the first coil 371b and the second coil 372b are disposed in the first direction (e.g., −Z-axis direction) and the second direction (e.g., +Z-axis direction) of the support member 390, it may be more advantageous in terms of space utilization than when disposed in only one direction.

Referring to FIG. 9, based on the support member 390, the first coil 371b and the second coil 372b may be disposed in the first direction (e.g., −Z-axis direction), and as at least a portion of the first coil 371b configured to transmit power and at least a portion of the second coil 372b configured to receive power are alternately disposed, the first coil 371b and the second coil 372b may be electrically connected in parallel.

As the first coil 371b and the second coil 372b are disposed in the first direction (e.g., −Z-axis direction) based on the support member 390, power may be transmitted and/or received more efficiently.

In this illustration and the following embodiments, an example is described in which the first coil 371b and the second coil 372b are disposed in the first direction (e.g., −Z-axis direction), but this is not limited thereto and may be disposed in the second direction (e.g., +Z-axis direction).

Referring to FIG. 9, the first coil 371b may include a (1-1)th coil 3711b disposed to form the inner peripheral surfaces of the coil assembly 370 and the first coil 371b, and a (1-2)th coil 3712b disposed to surround the outer peripheral surface of the (1-1)th coil 3711b.

Further, the second coil 372b may include a (2-1)th coil 3721b disposed to form the outer peripheral surfaces of the coil assembly 370 and the second coil 372b, and a (2-2)th coil 3722b disposed such that the outer peripheral surface is surrounded by the (2-1)th coil 3721b.

Further, the (1-2)th coil 3712b and the (2-2)th coil 3722b may be alternately disposed when viewed from the second direction (e.g., +Z-axis direction).

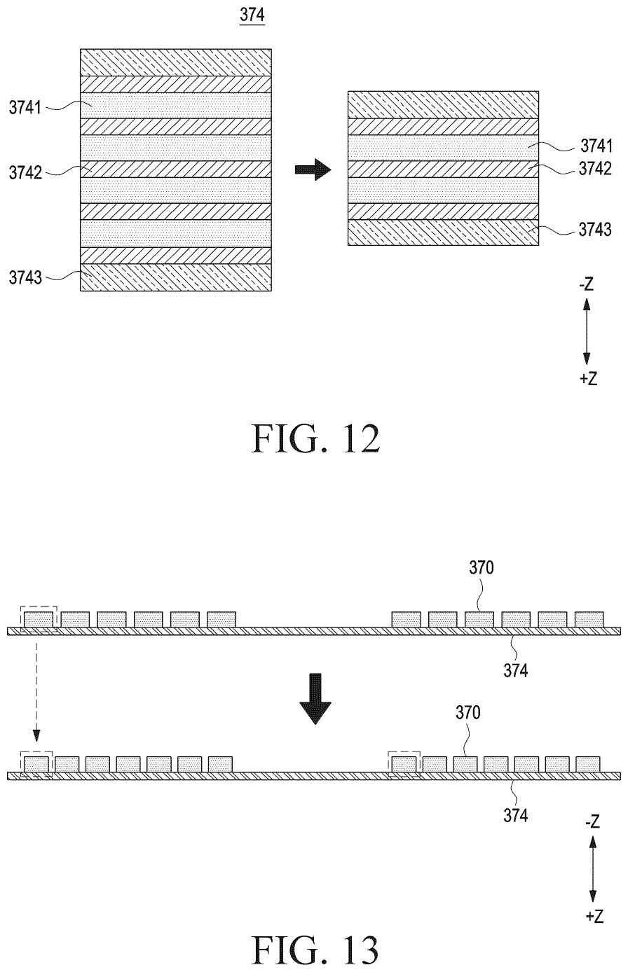

FIG. 10 is a view illustrating a cross-sectional view illustrating a coil assembly and a shielding member according to an embodiment of the disclosure. FIG. 11 is a graph illustrating inductance according to thickness of a shielding member according to an embodiment of the disclosure. FIG. 12 is a view illustrating a cross-sectional view illustrating a shielding member according to an embodiment of the disclosure.

Referring to FIGS. 10 to 12, the illustrated embodiments may be combined with the embodiments of FIGS. 1 to 9 or FIGS. 13, 14A to 14D, 15, and 16.

Some or all of the components described with reference to FIGS. 10 to 12 may be the same as the components described with reference to FIGS. 1 to 9. Some or all of the components described with reference to FIGS. 10 to 12 may be the same as all or some of the components described with reference to FIGS. 13, 14A to 14D, 15, and 16.

Referring to FIG. 10, the shielding member 374 is disposed between the coil assembly 370 and an electronic component (e.g., a processor), thereby preventing electromagnetic interference that may occur in the electronic component due to the magnetic field generated from the coil assembly 370 and enhancing the power transmission/reception efficiency of the coil assembly 370.

The shielding member 374 may be disposed in the first direction (e.g., −Z-axis direction) of the coil assembly 370. Further, the shielding member 374 may be disposed in the second direction (e.g., +Z-axis direction) of the electronic component (e.g., a processor). Accordingly, the influence of the magnetic field generated from the coil assembly 370 on the electronic component (e.g., a processor) may be decreased. Further, signal interference that may occur from the electronic component (e.g., a processor) may be minimized, thereby maintaining the overall performance of the electronic device 101.

Further, the shielding member 374 may reduce magnetic field loss of the coil assembly 370 and increase power transmission/reception efficiency. In a wireless power transmission/reception system, the magnetic field may be affected by the surrounding environment, and efficiency may decrease if unnecessary magnetic loss occurs. By disposing the shielding member 374 between the coil assembly 370 and the electronic component (e.g., a processor), the magnetic field generated from the coil assembly 370 does not spread in unnecessary directions and may more effectively transmit/receive power to the opposing coil. As a result, loss in the power transmission process is decreased, and wireless charging performance may be enhanced.

The shielding member 374 may also increase the stability of the electronic component (e.g., a processor). The strong magnetic field generated from the coil assembly 370 may affect the operation of the electronic component (e.g., a processor), and the shielding member 374 blocks such magnetic interference to protect the electronic component (e.g., a processor) so that it may operate normally, thereby increasing the reliability of the entire electronic device 101.

Permeability is a physical characteristic indicating the ease with which a magnetic field passes through the interior of a material, and materials with high permeability more effectively concentrate the magnetic field to enhance electromagnetic performance.

Inductance is an electrical characteristic indicating the degree to which a coil resists changes in current, and is determined by the number of turns, shape, and size of the coil and the characteristics of the shielding member 374. As inductance increases, the coil may store more magnetic energy, enhancing wireless power transmission performance, but if it is too high, the resonant frequency may change, requiring design optimization.

The shielding member 374 may be composed of a material with high permeability. When the shielding member 374 is disposed in the first direction (e.g., −Z-axis direction) of the coil assembly 370, the inductance (L) of the coil disposed inside the coil assembly 370 may be increased. The higher the permeability of the shielding member 374 and the thicker it is, the more the inductance (L) increases, through which wireless power transmission/reception performance may be enhanced.

However, in order to make the electronic device 101 thinner, it is necessary to reduce the thickness of the shielding member 374 in the process of making the coil assembly 370 thinner, and accordingly, the inductance (L) value may also decrease. If the inductance decreases below a predetermined value, charging efficiency may decrease, so when the shielding member 374 is made thinner, a design to compensate for the decreasing inductance is needed.

Referring to FIG. 12, the shielding member 374 may include a shielding layer 3741, an adhesive layer 3742, and a protective layer 3743.

The shielding layer 3741 is formed of a nanocrystalline material and may have high permeability. As a result, the inductance of the coil assembly 370 may be increased and the magnetic field leaking to the electronic component (e.g., a processor) may be blocked. For example, nanocrystalline provides excellent magnetic shielding performance even at very thin thickness, contributing to making the electronic device 101 thinner while maintaining the efficiency of wireless power transmission. Further, the shielding layer may be formed with a thickness of up to 18 μm.

The adhesive layer 3742 may be disposed between different shielding layers 3741, or between the shielding layer 3741 and the protective layer 3743, to connect different shielding layers 3741 or the shielding layer 3741 and the protective layer 3743.

Further, the protective layer 3743 may protect the outer surface of the shielding member 374 and may enhance durability by protecting the shielding layer 3741 from the external environment (moisture, dust, mechanical impact, etc.).

Referring to FIG. 11, it may be identified that as the thickness of the shielding member decreases, the inductance also decreases.

For example, when applying a nanocrystalline material with a permeability of 1500 as the shielding layer 3741, the shielding member 374 may be configured by stacking multiple sheets of shielding layers 3741. Referring to FIG. 12, since the shielding layer 3741 composed of nanocrystalline is limited to a maximum thickness of 18 μm, it may be configured by stacking a plurality of shielding layers 3741 to secure the desired inductance value and/or shielding performance.

Referring to FIG. 12, when configuring the shielding member 374 by stacking 4 sheets of shielding layers 3741, a shielding member 374 with a thickness of 72 μm of shielding layers 3741 is formed, and referring to FIG. 11, the inductance (L) is about 13 μH.

Further, when configuring the shielding member 374 by stacking 2 sheets of shielding layers 3741 to reduce the thickness of the shielding member 374, a shielding member 374 with a thickness of 36 μm of shielding layers 3741 is formed, and the inductance (L) decreases by about 1 μH to 12 μH.

In this illustration and the following embodiments, an example is described in which an adhesive layer 3742 is formed between shielding layers 3741 to adhere the shielding layers 3741, but this is not limited thereto.

Further, in this illustration and the following embodiments, an embodiment of stacking 2 sheets of shielding layers 3741 is described as an example, but the thickness and number of shielding layers 3741 may be changed according to the design specifications of the electronic device.

As described above, when inductance (L) decreases due to thinning of the shielding member 374, additional design may be needed in the coil design process to compensate for the decreased inductance. For example, there is a need to secure inductance by adjusting the number of turns of the coil assembly 370 or optimizing the coil arrangement.

FIG. 13 is a view illustrating a cross-sectional view illustrating a coil assembly and a shielding member according to an embodiment of the disclosure.

Referring to FIG. 13, the illustrated embodiment may be combined with the embodiments of FIGS. 1 to 12 or FIGS. 14A to 14D, 15, and 16.

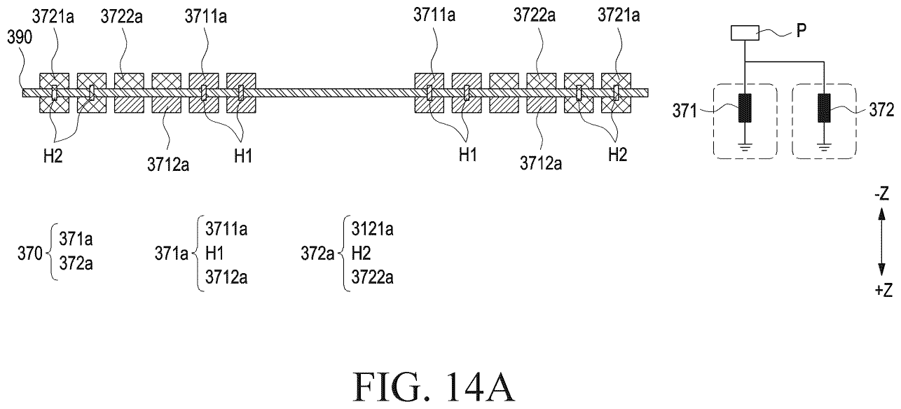

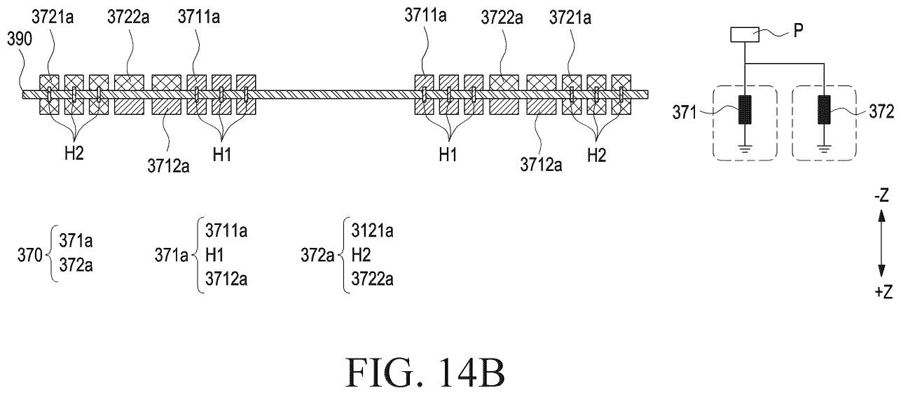

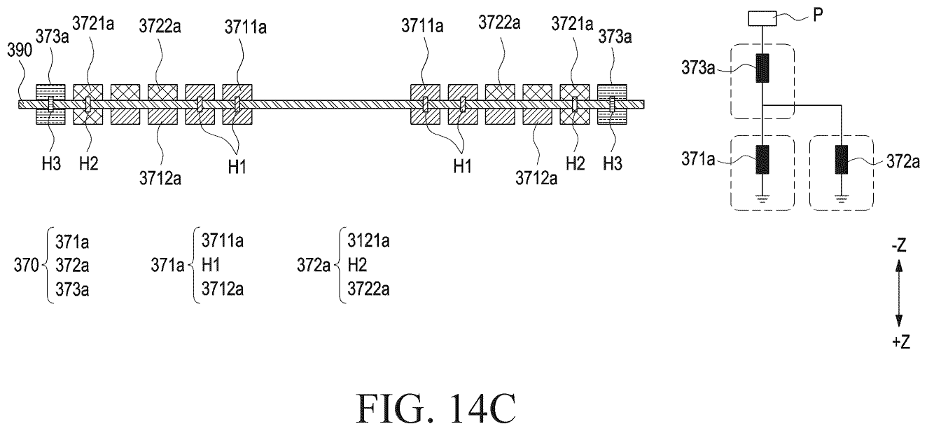

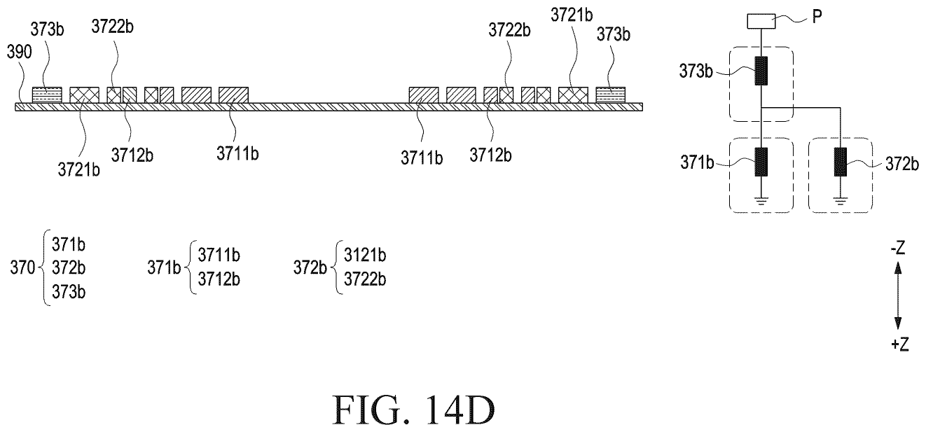

The components described with reference to FIG. 13 may be identical in whole or part to the components described with reference to FIGS. 1 to 12. The components described with reference to FIG. 13 may be identical in whole or part to the components described with reference to FIGS. 14A to 14D, 15 and 16.

The number of turns refers to the number of times a coil is wound and may be a design element that directly affects electromagnetic induction phenomena and inductance (L).

As the number of turns increases in the coil assembly 370, a stronger magnetic field is formed, and accordingly, inductance increases, which may enhance wireless power transmission/reception performance.

However, if the number of turns is increased within the same area, the line width of the coil (e.g., thickness in a direction perpendicular to the first direction) becomes narrower, and resistance (R) increases, which may increase power loss. Therefore, without changing the number of turns, design may be needed to increase inductance while minimizing resistance increase through coil arrangement inside the coil assembly.

FIG. 14A is a view illustrating a cross-sectional view and an equivalent circuit diagram illustrating a coil assembly according to an embodiment of the disclosure. FIG. 14B is a view illustrating a cross-sectional view and an equivalent circuit diagram illustrating a coil assembly according to an embodiment of the disclosure. FIG. 14C is a view illustrating a cross-sectional view and an equivalent circuit diagram illustrating a coil assembly according to an embodiment of the disclosure. FIG. 14D is a view illustrating a cross-sectional view and an equivalent circuit diagram illustrating a coil assembly according to an embodiment of the disclosure.

Referring to FIGS. 14A to 14D, the illustrated embodiments may be combined with the embodiments of FIGS. 1 to 13 or FIGS. 15 and 16.

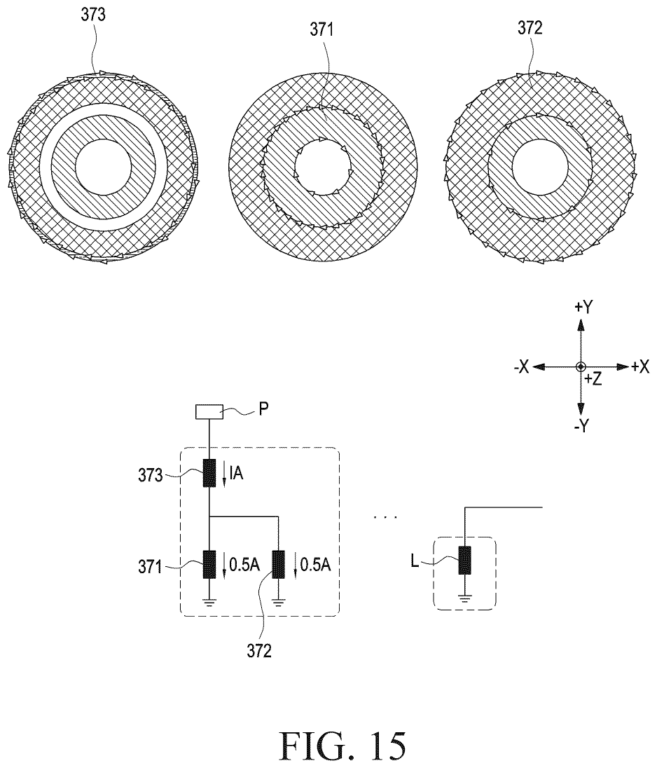

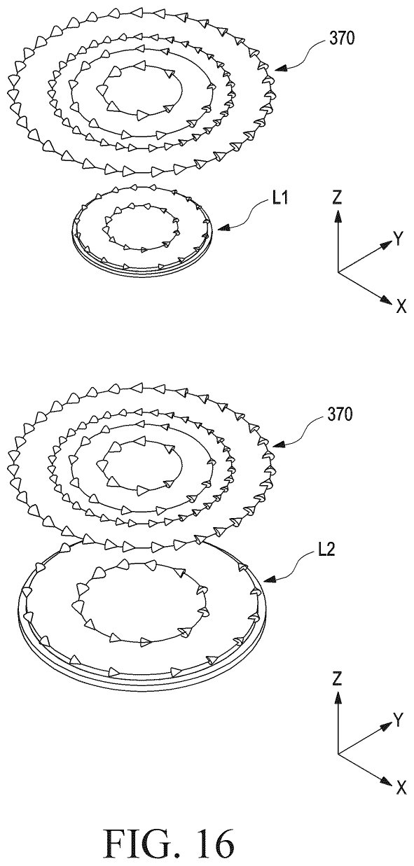

The components described with reference to FIGS. 14A to 14D may be identical in whole or part to the components described with reference to FIGS. 1 to 13. The components described with reference to FIGS. 14A to 14D may be identical in whole or part to the components described with reference to FIGS. 15 and 16.

FIG. 14A is a view illustrating a cross-sectional view and an equivalent circuit diagram illustrating the coil assembly of the embodiment according to FIG. 8 described above.

FIG. 14B is a view illustrating a cross-sectional view and an equivalent circuit diagram illustrating a coil assembly in which the number of turns of the coil is increased in the coil assembly of the embodiment according to FIG. 8.

As described above, the embodiment illustrated in FIG. 14B may be an embodiment in which, to increase the number of turns of the coil within the same area, the number of turns of the (1-1)th coil 3711 and the (2-1)th coil 3721 is increased, and the line width of the (1-1)th coil 3711 and the (2-1)th coil 3721 is decreased.

The embodiment illustrated in FIG. 14A has the (1-1)th coil 3711 and the (2-1)th coil 3721 configured with 2 turns, and the embodiment according to FIG. 14B may have the (1-1)th coil 3711 and the (2-1)th coil 3721 configured with 3 turns.

As a result, the embodiment illustrated in FIG. 14B may form higher inductance than the embodiment according to FIG. 14A, but may form smaller power transmission/reception efficiency as the resistance value increases.

The embodiment illustrated in FIG. 14C is an embodiment in which the outermost turn of the (2-1)th coil 3721a of the embodiment according to FIG. 8 is redisposed with a third coil 373a capable of transmitting power to an external electronic device or receiving power from a wireless power transmission device. Further, the embodiment according to FIG. 14D refers to an embodiment in which the outermost turn of the (2-1)th coil 3721b of the embodiment according to FIG. 9 is redisposed with a third coil 373b capable of transmitting power to an external electronic device or receiving power from a wireless power transmission device.

The third coil 373a and 373b may have a ring shape surrounding the outer peripheral surface of the second coil 372a and 372b when viewed from the second direction (e.g., +Z-axis direction), and may be configured to form the outer peripheral surface of the coil assembly 370. Further, the third coil 373a and 373b may be electrically connected in series with the first coil 371 and the second coil 372.

Referring to FIG. 14C, the third coil 373a may be disposed in the first direction (e.g., −Z-axis direction) and the second direction (e.g., +Z-axis direction) of the support member.

The third hole H3 substantially parallel to the second direction may be formed at a position corresponding to the third coil 373a of the support member 390. Accordingly, electrical separation of the third coil 373a by the support member 390 may be prevented.

Specifically, by forming the third hole H3 in the support member 390, the portion disposed in the first direction (e.g., −Z-axis direction) and the portion disposed in the second direction (e.g., +Z-axis direction) of the third coil 373 may be connected to operate as a single coil.

Referring to FIG. 14D, the third coil 373b may be disposed in the same direction as the first coil 371b and the second coil 372b based on the support member 390.

The embodiments illustrated in FIGS. 14C and 14D are embodiments with the same area and the same number of turns as the conventional embodiments according to FIGS. 8 and 9, but by changing the circuit configuration, each coil may be connected in series and parallel.

FIG. 15 is a view illustrating a plan view and an equivalent circuit diagram illustrating a coil assembly according to an embodiment of the disclosure. FIG. 16 is a view illustrating a portion of a coil assembly and an external coil according to an embodiment of the disclosure.

Referring to FIGS. 15 and 16, the illustrated embodiments may be combined with the embodiments illustrated in FIGS. 1 to 13, and 14A to 14D.

The components described with reference to FIGS. 15 and 16 may be identical in whole or part to the components described with reference to FIGS. 1 to 13, and 14A to 14D.

FIG. 15 is a diagram specifically illustrating a perspective view and an equivalent circuit diagram illustrating the embodiment according to FIG. 14C.

Referring to FIG. 15, as current increases, the magnetic field of the coil becomes stronger, which may also affect inductance (L). As a result, since the current flowing through the third coil 373 is higher than the current flowing through the first coil 371 and the second coil 372, the third coil 373 may have a significant impact on the inductance value of the coil assembly 370.

Further, when the outer diameter of the coil increases, the area affected by the magnetic field increases, and inductance (L) also tends to increase accordingly. This is because inductance is proportional to the square of the coil radius (R²), and when the outer diameter of the coil is increased while maintaining the same number of turns, the path of the magnetic field becomes longer and may include more magnetic flux.

As a result, as the current flowing through the third coil 373, which has the largest outer diameter, increases, the total inductance value may increase without increasing the number of turns. Further, since the outer diameter of the third coil 373 is wide, the cross-sectional area of the conductor increases, so the resistance increase due to the inductance increase may also be small.

In the disclosure and the following embodiments, an example is described in which the current of the embodiment according to FIG. 14C is equally distributed to the first coil 371 and the second coil 372 connected in parallel, but this is not limited thereto. For example, current may be unevenly distributed to the first coil 371 and the second coil 372.

Equations 1 to 5 below are mathematical equations representing charging efficiency during power transmission/reception through inductance value (L) and resistance value (R).

$${Q}_{TX} = \frac{ω {L}_{TX}}{{R}_{PTX}} \qquad Equation 1$$

$${Q}_{RX} = \frac{ω {L}_{RX}}{{R}_{PRX} + {R}_{L}} \qquad Equation 2$$

$$efficiency = \frac{{R}_{ref 1}}{{R}_{rx} + {R}_{ref 1}} * \frac{{R}_{L}}{{R}_{L} + {R}_{RPX}} = \frac{{k}^{2} {Q}_{rx} {Q}_{RX}}{1 + {k}^{2} {Q}_{rx} {Q}_{RX}} * \frac{{R}_{L}}{{R}_{L} + {R}_{RPX}} \qquad Equation 3$$

$$transmission - reception transfer efficiency = \frac{{k}^{2} {Q}_{rx} {Q}_{RX}}{1 + {k}^{2} {Q}_{rx} {Q}_{RX}} \qquad Equation 4$$

$$receiver efficiency = \frac{{R}_{L}}{{R}_{L} + {R}_{RPX}} \qquad Equation 5$$

Table 1 below is a table comparing the power transmission/reception efficiency of the coil assembly 370 according to the embodiments of FIGS. 14A to 14C and the external coil L when the permeability of the above-described shielding member (e.g., the shielding member 374 of FIG. 10) is 1500 and the thickness of the above-described shielding member (e.g., the shielding member 374 of FIG. 10) is 36 μm, calculated according to Equation 3 above.

Specifically, efficiency was compared through a first external coil L1 and a second external coil L2, where the first external coil L1 refers to a share Tx coil with an outer diameter of 25 mm, and the second external coil refers to a WPC Tx coil with an outer diameter of 40 mm.

Further, the outer diameter of the first coil 371 is the same at 29.1 mm, the inner diameter is 13.5 mm, and the outer diameter of the second coil 372 is 44 mm for FIGS. 14A and 14B, 42.5 mm for FIG. 14C, and the inner diameter is the same at 24.5 mm.

TABLE 1

| Counterpart | | | | | |
|---|---|---|---|---|---|
| Coil | embodiment | L(μH) | R(ohm) | k | efficiency(%) |
| L1 | FIG. 14A | 9.44 | 0.53 | 0.596 | 71.6 |
| | FIG. 14B | 10.78 | 0.57 | 0.596 | 70.3 |
| | FIG. 14C | 10.46 | 0.55 | 0.572 | 71.3 |
| L2 | FIG. 14A | 12.96 | 1.01 | 0.753 | 82.1 |
| | FIG. 14B | 14.91 | 1.07 | 0.753 | 81.7 |
| | FIG. 14C | 14.45 | 1.04 | 0.767 | 82.1 |

In the case of the first external coil L1, the embodiment illustrated in FIG. 14C has a larger current flowing through the third coil 373, and because the outer diameter difference between the first external coil L1 and the third coil 373 is large, the k value becomes smaller, so charging efficiency decreases compared to the embodiment according to FIG. 14A, but the inductance value increases compared to the embodiment according to FIG. 14A and may have higher efficiency than the embodiment according to FIG. 14B, which simply increased the number of turns.

In the case of the second external coil L2, the embodiment illustrated in FIG. 14C, when compared with the embodiment illustrated in FIG. 14A, increased inductance by about 1.5 μH, resistance by 0.03 ohm, and k by 0.014. In the embodiment illustrated in FIG. 14C, compared to the embodiment illustrated in FIG. 14A, although resistance increased, inductance and k also increased, so it may be identified that efficiency is maintained the same as the existing parallel structure. However, the embodiment illustrated in FIG. 14B has decreased efficiency due to high resistance increase and no k increase.

Referring to the embodiment illustrated in FIG. 14C, the coil assembly 370 may form high inductance by connecting the third coil 373 in series with the first coil 371 and the second coil 372 that are connected in parallel. As a result, the power transmission efficiency of the coil assembly may be enhanced.

The disclosure relates to an electronic device. According to an embodiment of the disclosure, there may be provided an electronic device 101 including a housing 301 including a rear plate 380 forming a rear surface facing a first direction of the electronic device, a coil assembly 370 disposed adjacent to the rear plate 380 in a second direction opposite to the first direction and configured to transmit or receive power, wherein the coil assembly 370 includes a first coil 371a configured to transmit power to an external electronic device and having a ring shape when viewed from the second direction, a second coil 372a configured to receive power from a wireless power transmission device and having a ring shape surrounding an outer peripheral surface of the first coil 371a when viewed from the second direction, a third coil 373a configured to transmit power to an external electronic device or receive power from a wireless power transmission device and having a ring shape surrounding an outer peripheral surface of the second coil 372a when viewed from the second direction, wherein the first coil 371a and the second coil 372a are electrically connected in parallel, and the third coil 373a is electrically connected in series with the first coil 371a and the second coil 372a.

According to an embodiment, the electronic device may be configured such that at least a portion of the first coil 371a overlaps at least a portion of the second coil 372a when viewed from the second direction.

According to an embodiment, the electronic device may further include a support member 390 having a planar shape perpendicular to the second direction, wherein the support member 390 overlaps the coil assembly 370 when viewed from the second direction and is disposed between portions of the coil assembly 370 to support the coil assembly 370.

According to an embodiment, the first coil 371a may include a (1-1)th coil 3711a configured to form an inner peripheral surface of the first coil 371a and disposed in the first direction and the second direction of the support member 390, and a (1-2)th coil 3712a disposed in the first direction or the second direction of the support member 390 and disposed to surround an outer peripheral surface of at least a portion of the (1-1)th coil 3711a when viewed from the second direction. A first hole H1 substantially parallel to the second direction may be formed in a position corresponding to the (1-1)th coil 3711a of the support member 390.

According to an embodiment, the second coil 372a may include a (2-1)th coil 3721a configured to form an outer peripheral surface of the second coil 372a and disposed in the first direction and the second direction of the support member 390, and a (2-2)th coil 3722a disposed in the first direction or the second direction of the support member 390 and disposed such that an outer peripheral surface thereof is surrounded by the (2-1)th coil 3721a when viewed from the second direction. A second hole H2 substantially parallel to the second direction may be formed in a position corresponding to the (2-1)th coil 3721a of the support member 390.

According to an embodiment, the electronic device may have a third hole H3 substantially parallel to the second direction formed in a position corresponding to the third coil 373a of the support member 390.

According to an embodiment, the electronic device may be configured such that the (1-2)th coil 3712a is disposed in the first direction of the support member 390, and the (2-2)th coil 3722a is disposed in the second direction of the support member 390.

According to an embodiment, the electronic device may be configured such that the (1-2)th coil 3712a is disposed in the second direction of the support member 390, and the (2-2)th coil 3722a is disposed in the first direction of the support member 390.

According to an embodiment, the electronic device may be configured such that the (1-2)th coil 3712a overlaps the (2-2)th coil 3722a when viewed from the second direction.

According to an embodiment, the third coil 373a may be configured to form an outer peripheral surface of the coil assembly 370 and be disposed in the first direction and the second direction of the support member 390.

According to an embodiment, the electronic device may further include a shielding member 374 disposed in the first direction of the coil assembly 370.

According to an embodiment, the shielding member 374 may include a shielding layer 3741 and an adhesive layer 3742 disposed alternately.

According to an embodiment, the shielding member 374 may be composed of two or fewer shielding layers 3741.

According to an embodiment, when viewed from the second direction, an outer diameter of the first coil 371a may be 30 mm or less.

According to an embodiment, when viewed from the second direction, an outer diameter of the second coil 372a may be 40 mm or more and 45 mm or less.

According to an embodiment, the ring-shaped first coil 371a, second coil 372a, and third coil 373a may be disposed to form concentric circles when viewed from the second direction.

According to an embodiment, the first coil 371a and the second coil 372a may be electrically connected in parallel, and the third coil 373a may be electrically connected in series with the first coil 371a and the second coil 372a.

The disclosure relates to an electronic device. According to an embodiment of the disclosure, an electronic device 101 includes a housing 301 including a rear plate 380 forming a rear surface facing a first direction of the electronic device, a coil assembly 370 disposed adjacent to the rear plate 380 in a second direction opposite to the first direction and configured to transmit or receive power. The coil assembly 370 may include a first coil 371a; 371b configured to transmit power to an external electronic device and having a ring shape when viewed from the second direction, a second coil 372a; 372b configured to receive power from a wireless power transmission device and having a ring shape with an outer diameter larger than the first coil 371a; 371b when viewed from the second direction, a third coil 373a; 373b configured to transmit power to an external electronic device or receive power from a wireless power transmission device and having a ring shape surrounding an outer peripheral surface of the second coil 372a; 372b when viewed from the second direction. The first coil 371a; 371b and the second coil 372a; 372b may be electrically connected in parallel, and the third coil 373a; 373b may be electrically connected in series with the first coil 371a; 371b and the second coil 372a; 372b.

According to an embodiment, the electronic device may further include a support member 390 having a planar shape perpendicular to the second direction, wherein the support member 390 overlaps the coil assembly 370 when viewed from the second direction and supports the coil assembly 370.

According to an embodiment, the support member 390 may be disposed between portions of the coil assembly 370, the second coil 372a may have a ring shape surrounding an outer peripheral surface of the first coil 371a when viewed from the second direction, at least a portion of the first coil 371a may be configured to overlap at least a portion of the second coil 372a when viewed from the second direction, and the support member 390 may be disposed between a (1-2)th coil 3712a that is at least a portion of the first coil 371a and a (2-2)th coil 3722a that is at least a portion of the second coil 372a.

According to an embodiment, the support member 390 may be disposed in the second direction of the coil assembly 370, the first coil 371b may include a (1-1)th coil 3711b disposed to form an inner peripheral surface of the first coil 371b and a (1-2)th coil 3712b disposed to surround an outer peripheral surface of the (1-1)th coil 3711b, the second coil 372b may include a (2-1)th coil 3721b disposed to form an outer peripheral surface of the second coil 372b and a (2-2)th coil 3722b disposed such that an outer peripheral surface thereof is surrounded by the (2-1)th coil 3721b, and the (1-2)th coil 3712b and the (2-2)th coil 3722b may be alternately disposed when viewed from the second direction.

According to an embodiment, the electronic device may further include a shielding member 374 disposed in the first direction of the coil assembly 370.

According to an embodiment, the electronic device according to the disclosure may implement efficient power transmission/reception in the coil assembly 370 within the electronic device 101 by providing the coil assembly 370 utilizing both series and parallel structures.

According to an embodiment, the coil assembly 370 according to the disclosure may form high inductance by connecting the third coil 373, which is the outermost coil, in series with the first coil 371 and the second coil 372 that are connected in parallel. As a result, the power transmission efficiency of the coil assembly may be enhanced.

According to an embodiment, the coil assembly 370 may compensate for inductance reduction due to thinning of the shielding member 374 by increasing the current flowing through the third coil 373, which is the outermost coil, thereby increasing the overall inductance contribution. That is, the size of the system may be downsized while maintaining efficient power transmission.

The effects obtainable from the disclosure are not limited to the effects mentioned above, and other effects not mentioned is clearly understood by those skilled in the art to which the disclosure pertains from the following description.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a housing including a rear plate forming a rear surface facing a first direction of the electronic device; and
a coil assembly disposed adjacent to the rear plate in a second direction opposite to the first direction, and configured to transmit or receive power,
wherein the coil assembly comprises:
a first coil configured to transmit power to an external electronic device and having a ring shape when viewed from the second direction,
a second coil configured to receive power from a wireless power transmission device outside of the electronic device, the second coil having a ring shape surrounding an outer peripheral surface of the first coil when viewed from the second direction, and
a third coil configured to transmit power to the external electronic device or receive power from the wireless power transmission device, the third coil having a ring shape surrounding an outer peripheral surface of the second coil when viewed from the second direction, and
wherein the first coil and the second coil are electrically connected in parallel, and the third coil is electrically connected in series with the first coil and the second coil.

2. The electronic device of claim 1, wherein, when viewed from the second direction, at least a portion of the first coil is configured to overlap at least a portion of the second coil.

3. The electronic device of claim 1, further comprising:
a support member having a planar shape perpendicular to the second direction, wherein the support member overlaps the coil assembly when viewed from the second direction and is disposed between portions of the coil assembly to support the coil assembly.

4. The electronic device of claim 3, wherein the first coil comprises:
a (1-1)th coil configured to form an inner peripheral surface of the first coil and disposed in the first direction and the second direction of the support member; and
a (1-2)th coil disposed in the first direction or the second direction of the support member and disposed to surround an outer peripheral surface of at least a portion of the (1-1)th coil when viewed from the second direction, wherein a first hole substantially parallel to the second direction is formed in a position corresponding to the (1-1)th coil of the support member.

5. The electronic device of claim 4, wherein the second coil comprises:
a (2-1)th coil configured to form an outer peripheral surface of the second coil and disposed in the first direction and the second direction of the support member; and
a (2-2)th coil disposed in the first direction or the second direction of the support member and disposed such that an outer peripheral surface of the (2-2)th coil is surrounded by the (2-1)th coil when viewed from the second direction,
wherein a second hole substantially parallel to the second direction is formed in a position corresponding to the (2-1)th coil of the support member.

6. The electronic device of claim 5, wherein a third hole substantially parallel to the second direction is formed in a position corresponding to the third coil of the support member.

7. The electronic device of claim 5,
wherein the (1-2)th coil is disposed in the first direction of the support member, and
wherein the (2-2)th coil is disposed in the second direction of the support member.

8. The electronic device of claim 5,
wherein the (1-2)th coil is disposed in the second direction of the support member, and
wherein the (2-2)th coil is disposed in the first direction of the support member.

9. The electronic device of claim 5, wherein when viewed from the second direction, the (1-2)th coil is configured to overlap the (2-2)th coil.

10. The electronic device of claim 3, wherein the third coil is configured to form an outer peripheral surface of the coil assembly and is disposed in the first direction and the second direction of the support member.

11. The electronic device of claim 1, further comprising:
a shielding member disposed in the first direction of the coil assembly.

12. The electronic device of claim 11, wherein the shielding member includes a shielding layer and an adhesive layer disposed alternately.

13. The electronic device of claim 1, wherein when viewed from the second direction, an outer diameter of the first coil is 30 mm or less.

14. The electronic device of claim 1, wherein when viewed from the second direction, an outer diameter of the second coil is 40 mm or more and 45 mm or less.

15. The electronic device of claim 1, wherein the first coil, the second coil, and the third coil are arranged to form concentric circles when viewed from the second direction.

16. An electronic device comprising:
a housing including a rear plate forming a rear surface facing a first direction of the electronic device; and
a coil assembly disposed adjacent to the rear plate in a second direction opposite to the first direction, and configured to transmit or receive power,
wherein the coil assembly includes:
a first coil configured to transmit power to an external electronic device and having a ring shape when viewed from the second direction,
a second coil configured to receive power from a wireless power transmission device outside of the electronic device and having a ring shape with an outer diameter larger than the first coil when viewed from the second direction, and
a third coil configured to transmit power to an external electronic device or receive power from a wireless power transmission device, and having a ring shape surrounding an outer peripheral surface of the second coil when viewed from the second direction, and
wherein the first coil and the second coil are electrically connected in parallel, and the third coil is electrically connected in series with the first coil and the second coil.

17. The electronic device of claim 16, further comprising:
a support member having a planar shape perpendicular to the second direction,
wherein the support member overlaps the coil assembly when viewed from the second direction and supports the coil assembly.

18. The electronic device of claim 17,
wherein the support member is disposed between portions of the coil assembly,
wherein the second coil has a ring shape surrounding an outer peripheral surface of the first coil when viewed from the second direction,
wherein at least a portion of the first coil is configured to overlap at least a portion of the second coil when viewed from the second direction, and
wherein the support member is disposed between a (1-2)th coil that is at least a portion of the first coil and a (2-2)th coil that is at least a portion of the second coil.

19. The electronic device of claim 17,
wherein the support member is disposed in the second direction of the coil assembly,
wherein the first coil includes:
a (1-1)th coil disposed to form an inner peripheral surface of the first coil, and
a (1-2)th coil disposed to surround an outer peripheral surface of the (1-1)th coil, and
wherein the second coil includes:
a (2-1)th coil disposed to form an outer peripheral surface of the second coil, and
a (2-2)th coil disposed such that an outer peripheral surface thereof is surrounded by the (2-1)th coil, and
wherein the (1-2)th coil and the (2-2)th coil are alternately disposed when viewed from the second direction.

20. The electronic device of claim 16, further comprising:
a shielding member disposed in the first direction of the coil.
